(19) United States
(12) Patent Application Publication
(10) Pub. No.: US 2026/0329375 A1
(43) Pub. Date: Oct. 22, 2026

(54) LOCATION PROCEDURE OF AN XR DEVICE

(71) Applicant: Telefonaktiebolaget LM Ericsson (publ), Stockholm (SE)

(72) Inventors: Tobias WIDMARK, LUND (SE); Fredrik DAHLGREN, LUND (SE); Alexander HUNT, TYGELSJÖ (SE); Martin EK, LUND (SE); Andreas KRISTENSSON, SÖDRA SANDBY (SE)

(73) Assignee: Telefonaktiebolaget LM Ericsson (publ), Stockholm (SE)

(21) Appl. No.: 19/491,546

(22) PCT Filed: Jun. 13, 2023
(86) PCT No.: PCT/SE2023/050588

§ 371 Date: Dec. 9, 2025

(51) Int. Cl. G06F 3/01; G06T 7/73; G06T 19/00

(52) U.S. Cl. CPC G06F 3/013; G06T 7/74; G06T 19/006; G06T 2207/20072; G06T 2210/56

(57) ABSTRACT

There is provided techniques for performing localization of an XR device. A method is performed by a controller. The method comprises prompting a user of the XR device to orient himself/herself towards a feature point in a real-world environment. The method comprises obtaining orientation data of the XR device for when the user is oriented towards the feature point. The method comprises performing localization of the XR device for matching the feature point to a 3D digital representation of the real-world environment by cross-referencing the orientation data with data points that in the 3D digital representation represent the feature point.

### TECHNICAL FIELD

Embodiments presented herein relate to a method, a controller, a computer program, and a computer program product for performing localization of an extended reality device.

### BACKGROUND

In general terms, virtual reality (VR) is a simulated experience that can be similar to or completely different from the real world. Non-limiting examples of VR technologies can be found in entertainment applications (such as video games, and movies), in education applications (such as medical or military training, robot navigation, construction modelling, and airplane simulation) and business applications (such as virtual meetings or computer conferencing). VR can be combined with augmented reality technologies and mixed reality technologies, sometimes referred to as extended reality technologies. VR systems are examples of more general extended reality (XR) systems, that in addition to VR systems also include augmented reality (AR) systems, and mixed reality (MR) systems.

XR systems commonly use either headsets or multi-projected environments to generate realistic images, sounds and other sensations that simulate a user's physical presence in a virtual environment defining the simulated experience. A user using an XR device is able to look around in the simulated experience, move around in it, and interact with virtual features or items. The effect is commonly created by headsets comprising a head-mounted display with a small screen to be placed in front of the eyes of the user. However, also a tablet computer, or mobile handset, such as a user equipment (UE), often referred to as a smart phone, equipped with a camera can be used as an XR device, using so-called pass-through technology. Pass-through technology that allows the user to see the real world beyond the XR device, often through an external camera arranged to stream images to the display at the XR device where a three-dimensional (3D) digital representation of one or more virtual objects can be provided as an overlay on the images of the real world. For such an overlay to be seamless, information of the location of the XR devices is needed.

In this respect, a process of localization called inside-out tracking can be used that utilizes cameras and sensors in the XR device to perform visual Simultaneous Localization and Mapping (SLAM), with no external sensors aiding the localization. This can be achieved using a variety of different camera types, such as stereo red-green-blue (RGB) cameras, infra-red (IR) cameras, Light Detection and Ranging (LiDAR) cameras, to name a few. However, there is a risk of privacy concerns regarding how the devices record and store the data needed for SLAM. For this reason, some users may want an XR device that have no outward-facing cameras whatsoever. Removing cameras makes localization of the device more cumbersome.

### SUMMARY

An object of embodiments herein is to provide efficient localization of an XR device that overcome the above-mentioned disadvantages.

A particular object is to provide efficient localization of an XR device that does not involve visual SLAM.

A particular object is to provide efficient localization of an XR device that does not involve the use of an outward-facing camera during the localization.

According to a first aspect there is presented a controller for performing localization of an XR device. The controller comprises processing circuitry. The processing circuitry is configured to cause the controller to prompt a user of the XR device to orient himself/herself towards a feature point in a real-world environment. The processing circuitry is configured to cause the controller to obtain orientation data of the XR device for when the user is oriented towards the feature point. The processing circuitry is configured to cause the controller to perform localization of the XR device for matching the feature point to a 3D digital representation of the real-world environment by cross-referencing the orientation data with data points that in the 3D digital representation represent the feature point.

According to a second aspect there is presented a computer program for performing localization of an XR device. The computer program comprises computer code which, when run on processing circuitry of a controller, causes the controller to perform actions. One action comprises the controller to prompt a user of the XR device to orient himself/herself towards a feature point in a real-world environment. One action comprises the controller to obtain orientation data of the XR device for when the user is oriented towards the feature point. One action comprises the controller to perform localization of the XR device for matching the feature point to a 3D digital representation of the real-world environment by cross-referencing the orientation data with data points that in the 3D digital representation represent the feature point. According to a third aspect there is presented a computer program product comprising a computer program according to the second aspect and a computer readable storage medium on which the computer program is stored. The computer readable storage medium could be a non-transitory computer readable storage medium.

Advantageously, these aspects provide efficient localization of an XR device whilst overcome the above-mentioned disadvantages

Advantageously, these aspects provide efficient localization of an XR device without using visual SLAM.

Advantageously, these aspects provide efficient localization of an XR device without using any camera during the localization.

Advantageously, these aspects therefore additionally provide the following benefits:
reduced privacy concerns due to less invasive sensors,
lower energy consumption due to neither being dependent on visual SLAM nor on the use of a camera,
lower manufacturing costs due to no use of camera parts.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, action, etc.” are to be interpreted openly as referring to at least one instance of the element, apparatus, component, means, module, action, etc., unless explicitly stated otherwise.

The actions of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates an XR device according to an embodiment;

FIG. 2 schematically illustrates a real-world environment in which a user wearing an XR device is located according to an embodiment;

FIG. 3 is a flowchart of methods according to embodiments;

FIG. 4 schematically illustrates localization of an XR device based on three feature points according to an embodiment;

FIG. 5 schematically illustrates views as displayed on an XR device according to an embodiment;

FIG. 6 is a flowchart of methods according to embodiments;

FIG. 7 is a schematic diagram showing functional units of a controller according to an embodiment;

FIG. 8 is a schematic diagram showing functional modules of a controller according to an embodiment; and

FIG. 9 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any action or feature illustrated by dashed lines should be regarded as optional.

The embodiments disclosed herein relate to techniques for performing localization of an XR device. In order to obtain such techniques, there is provided a controller, a method performed by the controller, a computer program product comprising code, for example in the form of a computer program, that when run on a controller, causes the controller to perform the method.

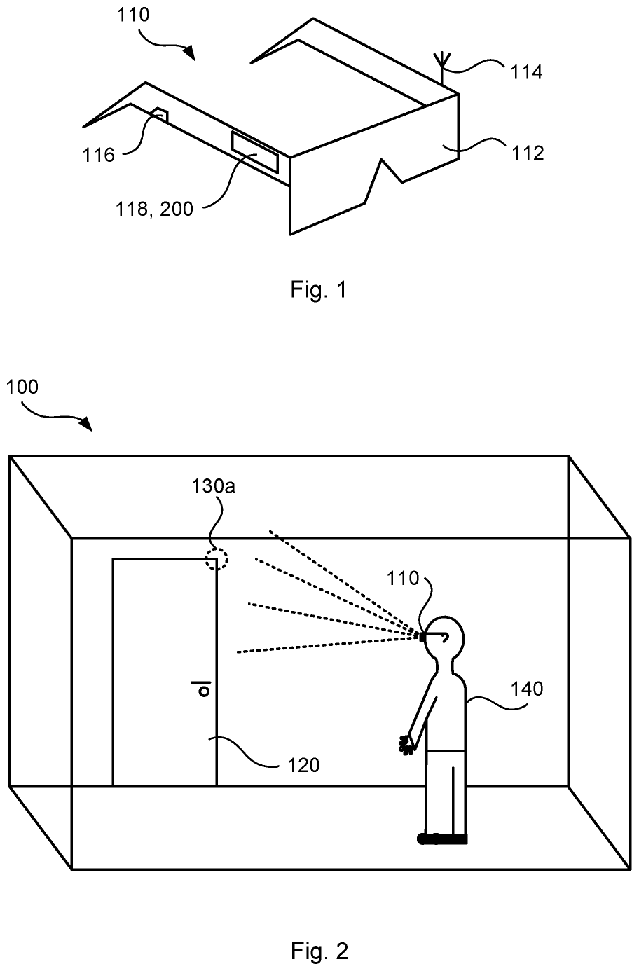

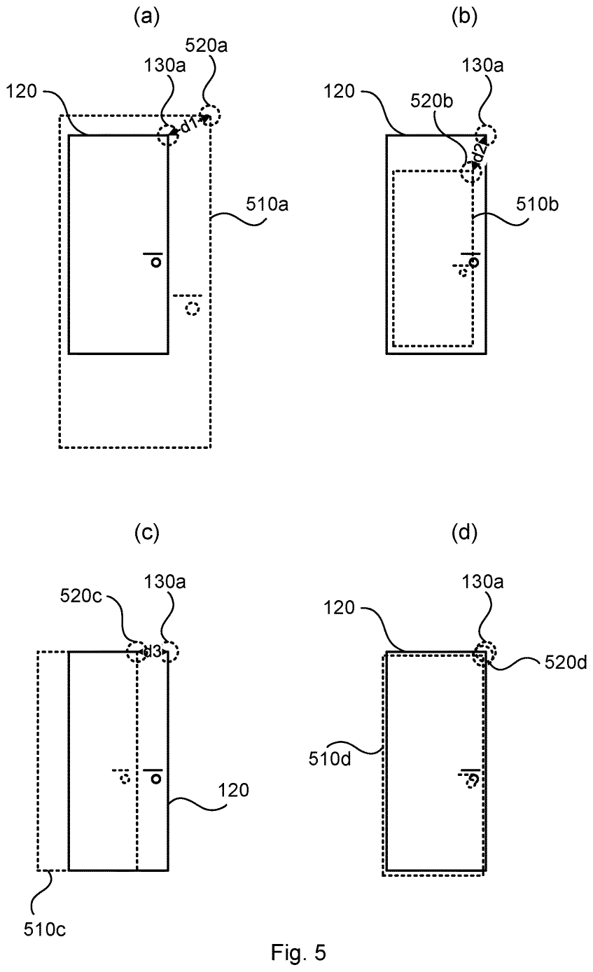

FIG. 1 is a schematic diagram illustrating an XR device 110 according to an embodiment. The XR device 110 is intended to be used by a user (see, FIG. 2). There could be different types of XR devices 110. FIG. 1 schematically illustrates an example where the XR device 110 is provided as a head-mounted display taking the shape of a pair of glasses. However, the XR device 110 could also be provided as a tablet computer, or smartphone, where a 3D digital representation is provided as an overlay on an image, as captured by the camera, of the real-world environment in which the XR device 110 is located is shown, and where images as captured by the camera are not stored for any further purpose than to just provide an (instantaneous) view of the real-world environment. The XR device 110 therefore comprises a user interface 112 for rendering a 3D digital representation on top of a real-world environment (see, FIG. 5). In some examples, the user interface 112 may comprise two small high-resolution monitors adapted to provide separate images for each eye for stereoscopic graphics rendering a 3D virtual environment, a binaural audio system, positional and rotational real-time head tracking (e.g., by means of an inertial measurement unit (IMU) for six degrees of movement. The XR device 110 might comprises a communication interface 112 for communicating with one or more other XR devices and/or with a controller 200. Although illustrated as an antenna, for example suitable for any type of radio communications (cellular was well as non-cellular), the communication interface 112 might be a wired communication interface, an infrared communication interface, a visible light communication interface, or some other kind of communication interface. In this respect, the XR device 110 might be configured for direct communication with another XR device or for communicating with another XR device via at least one other device, such as a controller 200, a mobile phone, personal computer, gaming machine, a server, a cloud computational system, or the like. The XR device 110 further comprises a processing unit 118, for controlling operation of the XR device 110. In some embodiments, the processing unit 118 implements the functionality of, or comprises, a controller 200. In the example of FIG. 1, the XR device 110 further comprises a speaker and/or microphone 116 or other type of audio playing or recording device. The XR device 110 might be configured to track movements made by its user. In this respect, how to perform localization of the XR device 110 will be disclosed below.

FIG. 2 is a schematic illustration of a real-world environment 100 in terms of a room. It is assumed that a user 140 wearing an XR device 110 is present in the room and that localization of the XR device 110 is to be performed. The room has a door 120. The upper right-hand corner of the door 120 is denoted a feature point 130a. How one or more feature points 130a can be used for performing localization of the XR device 110 will be disclosed next.

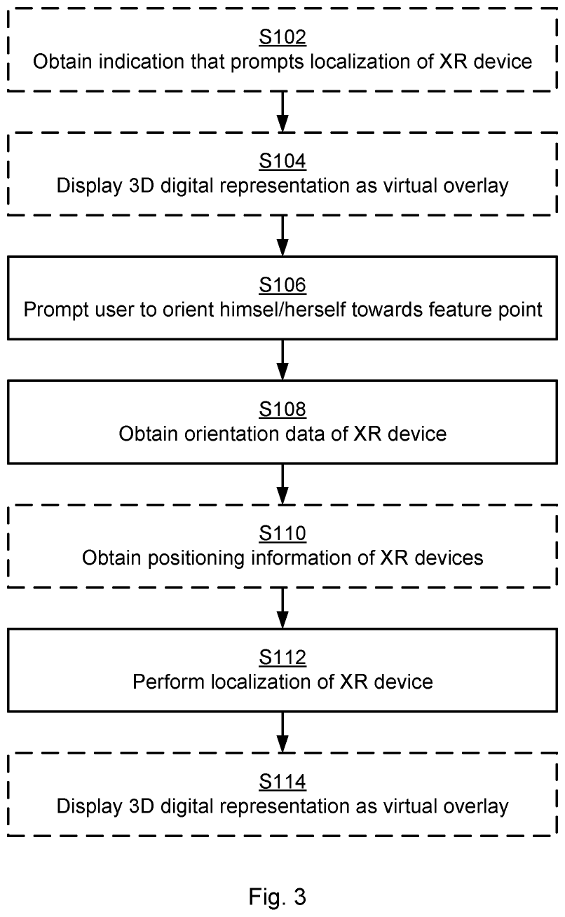

FIG. 3 is a flowchart illustrating embodiments of methods for performing localization of the XR device 110. The methods are performed by the controller 200. The controller 200 comprises processing circuitry 210. The methods are advantageously provided as a computer program 920.

S106: The controller 200 prompts a user 140 of the XR device 110 to orient himself/herself towards a feature point 130a:130c in a real-world environment 100.

S108: The controller 200 obtains orientation data of the XR device 110 for when the user 140 is oriented towards the feature point 130a:130c.

The user 140 might confirm, e.g., by providing a gesture, voice command, input via a hand control or other type of device, etc. when he/she is oriented towards the feature point 130a:130c. Once the user 140 has been oriented towards the feature point 130a:130c, the registered orientation data is used to determine where the user 140 is located, and thus where the XR device 110 is located, matching the feature point 130a:130c to a 3D digital representation 410a:410c of the real-world environment 100.

S112: The controller 200 perform localization of the XR device 110. The localization of the XR device 110 is performed for matching the feature point 130a:130c to a 3D digital representation 410a:410c of the real-world environment 100. The localization of the XR device 110 is performed by the controller 200 cross-referencing the orientation data with data points that in the 3D digital representation 410a:410c represent the feature point 130a:130c.

Embodiments relating to further details of performing localization of an XR device 110 as performed by the controller 200 will now be disclosed with continued reference to FIG. 3.

There may be different triggers for when the controller 200 is to prompt the user 140 of the XR device 110 to orient himself/herself towards the feature point 130a:130c in S106. In some aspects, the user 140 of the XR device 110 is prompted to orient himself/herself towards the feature point 130a:130c when calibration (in terms of localization) of the XR device 110 is needed. For example, assuming that localization of the XR device 110 has been performed once, an XR device 110 provided with an IMU or other type of inertial sensor, can use dead reckoning to estimate updates to the position of the XR device 110. Such updates can be provided as input to SLAM algorithms, or the like. However, the updates of the position of the XR device 110 are estimates that as such have drift errors that increase over time.

Furthermore, different applications as run by the XR device 110 might have different needs for position accuracy. Therefore, in some embodiments, the processing circuitry 210 is configured to cause the controller 200 to perform (optional) action S102.

S102: The controller 200 obtains an indication that prompts localization of the XR device 110 to be performed.

The user 140 of the XR device 110 is then prompted to orient himself/herself towards the feature point 130a:130c in the real-world environment 100 in response thereto (i.e., in response to the controller 200 having obtained the indication in S102).

In this respect, there can be different types of indications that prompts localization of the XR device 110 to be performed. In some non-limiting examples, the indication pertains to any, or any combination, of:
an indication of unexpected change of luminosity in the real-world environment 100,
an indication of deviation from an expected correspondence between the 3D digital representation 410a:410c and the real-world environment 100,
an indication from a program or an application requiring higher positioning accuracy or confirmation of position of the XR device 110 in the real-world environment 100,
user input indicating a need for calibration of the XR device 110,
an indication of deviation from an expected position of the XR device 110 relative other XR devices.

For example, using a light sensor and using information of light sources in the real-world environment 100 (such as fixed positioned lamps, windows during daytime with known current sunlight situation based on geo position and weather data, etc.), it can be identified whether the light sensor detects a change of luminosity in the real-world environment 100 that does not correlate with the expected change based on position and estimated movement. For example, if the XR device 110 is equipped with a radar device, then the distance to, for example, physical objects in the real-world environment 100 can be estimated and compared with the expected distance (as given by an expected correspondence between the 3D digital representation 410a:410c and the real-world environment 100) to these physical objects based on the estimated position. Too large deviation can trigger a re-calibration depending on the accuracy need of the application run in the XR device 110. For example, the user 140 might identify that virtual objects are not positioned in logical places, request a re-calibration, and thereby provide user input indicating a need for calibration of the XR device 110. For example, in case there are other XR devices that have estimated positions in the vicinity within the real-world environment 100, then a relative deviation of the positions can be estimated using different device-to-device communication techniques, such as Bluetooth, possibly in combination with angle-of-arrival measurements or angle-of-departure measurements, can be used estimate a relative drift in terms of position between the XR devices. The higher the number of XR devices, the more accurate this becomes, and the easier to determine for which XR device the position has drifted (if not all). This is one way of using an indication of deviation from an expected position of the XR device 110 relative other XR devices to determine whether or not localization of the XR device 110 is needed. In this respect, as already noted, different applications as run in the XR device 110 might have different needs for accuracy with respect to position. The XR device 110 might have an estimated position with an estimated accuracy which is acceptable for one application (e.g., when only visualizing text). However, if a further application is started up in the same XR device, where this further application has much higher accuracy needs in terms of position (e.g., showing virtual objects at logical places, e.g., an avatar sitting on a chair) this might trigger a request for re-calibration and thus server as an indication that localization of the XR device 110 is needed.

There could be different ways in which the user 140 of the XR device 110 is prompted to orient himself/herself towards the feature point 130a:130c in the real-world environment 100. In some aspects, a message is played out on the XR device 110. That is, in some embodiments, the user 140 of the XR device 110 is prompted to orient himself/herself towards the feature point 130a:130c in the real-world environment 100 by the controller 200 causing a message to be played out on the XR device 110. There could be different types of messages that are played out, depending on the type, and capabilities of the XR device 110. In some non-limiting examples, the message is played out as a text message that thus is displayed to the user 140. In some non-limiting examples, the message is played out as an audio message.

In some aspects, the 3D digital representation 410a:410c of the real-world environment 100 is assumed to exist before the localization of the XR device 110 is performed. That is, according to some embodiments, the 3D digital representation 410a:410c has been generated prior to the localization being performed. In this respect, the 3D digital representation 410a:410c might have been generated previously using another device, such as another XR device, a dedicated camera device, or the like. The 3D digital representation 410a:410c might even have been generated previously using the same XR device 110, but where for some reason the 3D digital representation 410a:410c has been removed from memory or otherwise been made inaccessible to the XR device 110. Still further, the 3D digital representation 410a:410c might have been generated already in connection to construction of the real-world environment 100 or in connection with later remodeling of the real-world environment 100.

There could be different types of 3D digital representations 410 a:410 c. In some embodiments, the 3D digital representation 410a:410c is a 3D scene graph of the real-world environment 100. In some embodiments, the 3D digital representation 410a:410c comprises point or mesh information of the real-world environment 100 and semantic information of objects in the real-world environment 100. In this respect, the 3D digital representation 410a:410c could take the form of a 3D scene graph. The semantic information represents tagged object information.

This information can be used by the controller 200 as part of the localization of the XR device 110. Therefore, in some embodiments, the feature point 130a:130c is selected based on location of the point or mesh information and/or the semantic information. In further detail, this information can used by the controller 200 to generate the feature point 130a:130c; relatively static objects such as walls, doorways and corners in the real-world environment 100 are semantically known also within the 3D digital representation 410a:410c, and are thus a good basis for the feature point 130a:130c. Such feature points 130a:130c could be stored based on earlier visits to the real-world environment 100. Over time the controller 200 can learn where certain types of feature points 130a:130c are. This could for instance be how corners of a room and doors normally are represented since there will be many users, many visits and many rooms with doors and corners.

Further, if one or more physical objects in the real-world environment 100 could, based on the semantic data about the room (e.g., as low corners in the room or windows that could have curtains over them), have a high risk of obscuring a feature point 130a:130c, then such a possibly obscured feature point 130a:130c is less favored over those feature points 130a:130c with higher likelihood of availability. There are different alternatives in case a feature point 130a:130c is occluded and cannot be seen by the user 140 from his/her current position. According to a first example, the user 140 might himself/herself request a new feature point 130a:130c. According to a second example, the user 140 is allowed to make a small movement in the real-world environment 100, where this movement can be estimated by using an IMU or other type of inertial sensor in the XR device 110.

Further in this respect, the number of feature points 130a:130c needed for the localization of the XR device 110 could vary, for example based on the required accuracy of the localization, but also with respect to the distance and/or angles between the XR device 110 and the feature points 130a:130c, and the relative distribution of feature points 130a:130c in the real-world environment 100. In some examples, it might be sufficient to use one single feature point 130a:130c to obtain localization of the XR device 110 with sufficient accuracy. However, in other examples, two or more feature points 130a:130c are needed. The feature points 130a:130c localization of the XR device 110 can then be based on triangulation. Therefore, in some aspects, the localization procedure (as defined by actions S106, S108, S112) is repeated for at least two feature points 130a:130c, e.g., allowing to use triangulation to obtain localization of the XR device 110. In particular, according to some embodiments, the feature point 130a:130c is a first feature point 130a, and the processing circuitry 210 is configured to cause the controller 200 to repeat the prompting and the obtaining for at least one second feature point 130b, 130c in the real-world environment 100, and to perform the localization of the XR device 110 also based on the at least one second feature point 130b, 130c.

The controller 200 might then determines the location of the user 140 (as part of localizing the XR device 110) by comparing where vectors meet, placing the user 140 virtually in the 3D digital representation 410a:410c. In particular, according to some embodiments, matching each of the first feature point 130a and the at least one second feature point 130b, 130c to the 3D digital representation 410a:410c comprises determining a respective vector. Each vector points towards a respective one of the first feature point 130a and the at least one second feature point 130b, 130c. The localization of the XR device 110 can then be defined by a coordinate in a plane or space where two or more of the vectors are estimated to cross each other.

As disclosed above, there can be different ways to select the feature points 130a:130c. For example, as noted above, feature points 130a:130c can be placed on relatively static objects such as walls, doorways and corners in the real-world environment 100. In some aspects, the feature points 130a:130c are distributed along a (straight) line and the user 140 is in S106 prompted to orient himself/herself by following the line from one feature point 130a:130c to the next. That is, the user 140 might in this way be prompted follow a line, or part of a line, instead of a specific feature point 130a:130c. In some examples, this is based on that the 3D digital representation 410a:410c includes such a line, which in the real-world environment 100 could correspond to a physical edge, like a doorframe or the joint between wall and ceiling or an actual painted line on the wall. The movement of the user 140 might then create a plane in which the position of the XR device 110 can be found. Such a line is less likely to be obstructed from view. Therefore, in some embodiments, the first feature point 130a and the at least one second feature point 130b, 130c are all placeable on one and the same straight line.

In some aspects, the placement of the feature points 130a:130c is based on taking the user's 140 likely position in a given real-world environment 100 into account. Based on the 3D digital representation 410a:410c, the controller 200 could favor feature points 130a:130c that would be easy viewable from positions a user 140 is expected to be at. For example, if the 3D digital representation 410a:410c has knowledge of a table often being in the middle of a room, and that the doorway to the room remains unobstructed, feature points 130a:130c might be selected to favor the user 140 standing in the doorway as that is where the user 140 is most likely to be. This can be extended to height as well; feature points 130a:130c visible from normal standing sight might be favored.

There might be different ways in which the orientation data of the XR device 110 is obtained for when the user 140 is oriented towards the feature point 130a:130c in S108. In some aspects, this depends on in what sense the user 140 is oriented towards the feature point 130a:130c. In one example, the user 140 simply gazes towards the feature point 130a:130c. That is, in some embodiments, the user 140 is prompted to orient himself/herself towards the feature point 130a:130c by gazing towards the feature point 130a:130c. Matching the feature point 130a:130c to the 3D digital representation 410a:410c might then comprise gaze tracking of the user 140. In other examples, the user 140 turns his/her head towards the feature point 130a:130c. That is, in some embodiments, the user 140 is prompted to orient himself/herself towards the feature point 130a:130c by directly facing the feature point 130a:130c. Matching the feature point 130a:130c to the 3D digital representation 410a:410c might then comprise pose tracking of the XR device 110.

This might require the user 140 to orient his/her head straight towards the feature point 130a:130c with the eyes thus looking in the boresight direction towards the feature point 130a:130c. That is, the user 140 can be prompted to look directly at the feature point 130a:130c, possibly with a visual indicator that indicates the boresight direction of the XR device 110. This enables head pose tracking to be achieved using data from e.g., an IMU or other type of inertial sensor in the XR device 110 to be used for the controller 200 to obtains the orientation data of the XR device 110. In this way, gaze-tracking can be avoided. The pose of the XR device 110 will then give the direction towards the feature point 130a:130c. This forces the user 140 to turn his/her head (or even complete body) to look towards the feature point 130a:130c.

As disclosed above, position information with respect to other XR devices within the real-world environment 100 can be used to determine whether or not localization of the XR device 110 is needed. Further in this respect, relative and/or absolute position information with respect to such other XR devices can also be used during the localization procedure itself. That is, one or more further XR devices (possibly worn by other users that are also present in the real-world environment 100) can share position information. In this way, all the XR devices in the real-world environment 100 can reduce the positioning error by collaborative triangulation. The XR devices could also sense other XR devices in the same real-world environment 100 using, for example, directional Bluetooth techniques or other types of device-to-device communication techniques. Therefore, according to some embodiments, the processing circuitry 210 is configured to cause the controller 200 to perform (optional) action S110.

S110: The controller 200 obtain first positioning information of the XR device 110 and second positioning information of at least one other XR device located in the real-world environment 100.

The localization of the XR device 110 can then further be based on a comparison between the first positioning information and the second positioning information.

Further, in case localization of the XR device 110 has been performed in a neighboring real-world environment 100 (such as when the XR device 110 was located in a neighboring room), such information can be used to localize the XR device 110 in the present real-world environment 100. For example, as the user 140 walks into a new room, the XR device 110 (with IMU-based support for dead reckoning) might estimate approximately where the user 140 enters the new room. Having access to a 3D digital representation 410a:410c of the real-world environment 100 comprising, for example, information of the position of doors into that room (and how the room relates to the adjacent room from which the user 140 is coming), the XR device 110 can have a prior estimate of position also in the new room. The localization procedure can then select feature points 130a:130c suitable for the estimated position of the XR device 110, and it is likely that the number of feature points 130a:130c needed will be fewer than if no prior estimate of the position of the XR device 110 is available.

In some aspects, once the localization procedure has been completed, a virtual overlay showing the 3D digital representation 410a:410c could be displayed in the XR device 110. If the user 140 is not satisfied with the calibration (as defined by the localization of the XR device 110), the user 140 might adjust his/her positioning manually through an interface. Additionally or alternatively, such an overlay could be displayed in the XR device 110 when the localization procedure has been initialized, for example in conjunction with prompting the user 140 to orient himself/herself towards the feature point 130a:130c. Hence, according to some embodiments, the processing circuitry 210 is configured to cause the controller 200 to, in conjunction with prompting the user 140 to orient himself/herself towards the feature point 130a:130c, and/or when having performed the localization of the XR device 110, perform (optional) action S104 and/or action S114:

S104/S114: The controller 200 displays the 3D digital representation 410a:410c as a virtual overlay on the XR device 110.

According to some embodiments, the virtual overlay comprises an indication, for example representing a data point 520a: 520d, of the feature point 130a:130c. This could aid the user 140 to orient himself/herself with respect to the 3D digital representation 410a:410c. In case the controller 200 displays the 3D digital representation 410a:410c as a virtual overlay on the XR device 110 once the localization procedure has been completed, the user 140 is allowed to determine how accurate the localization of the XR device 110 has been. This could be achieved by having an outlined mesh display from the virtual perspective of the user 140, where lines in the display should ideally match up with lines in the real-world environment 100 (such as walls meeting the floor/ceiling, corners, table edges, etc.). It could also be a small 3D overview of the real-world environment 100 showing the location and movement of the User 140.

For example, the XR device 110 might, in the 3D digital representation 410a:410c, provide an illustration of the needed structure of the real-world environment 100 to show the next feature point 130a:130c, e.g., by showing the gridlines of the walls and roof in such a way it estimates that the user 140 can see the room given how the XR device 110 is currently positioned and directed. The first time the needed structure is illustrated, the orientation with respect to the real-world environment 100 is likely very wrong, but as the user 140 moves his/her head and/or his/her gaze towards the first feature point 130a, the orientation will improve. The user 140 can then be prompted to move his/her head and/or his/her gaze towards one or more further feature points 130b:130c, where the outline structure of the room based on the updated estimation of position and direction is shown. This time, the orientation is likely more correct. The XR device 110 is thereby able to visualize a gradually better oriented outline structure of the room. As disclosed above, the number of needed feature points 130a:130c might vary depending on the real-world environment 100, the needed accuracy of the application run in the XR device 110, any access to additional information, other XR devices in the vicinity, etc.

Further, if the controller 200 detects that the user's 140 relative positioning is not congruent with the expected movements when looking at the feature points 130a:130c, the localization procedure might be performed once again, possible using another set of feature points 130a:130c.

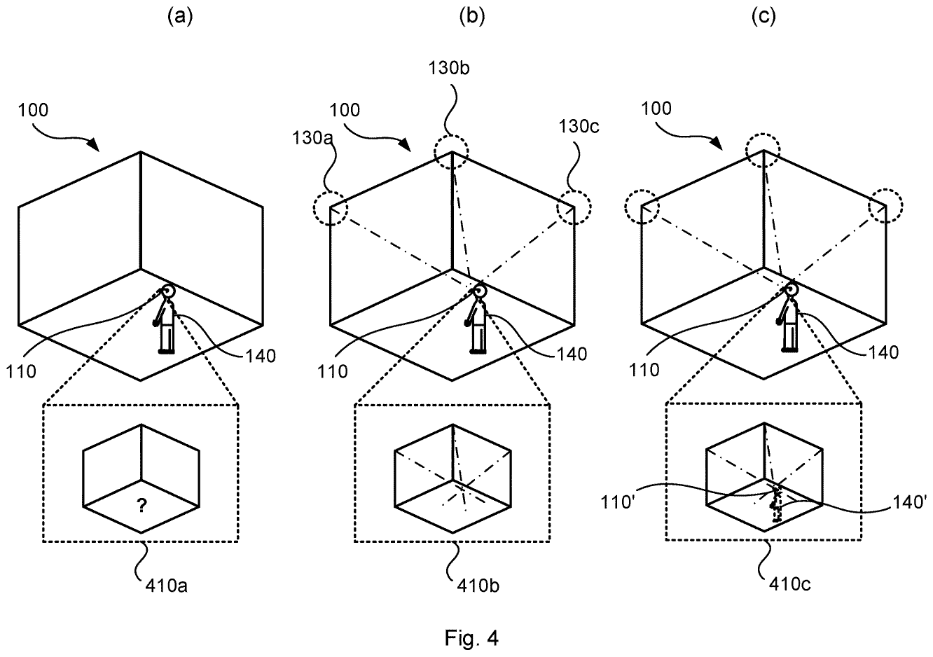

In FIG. 4 is schematically illustrated an example where the localization of an XR device 110 is based on three feature points 130a:130c. The XR device 110 that has access to a 3D digital representation 410a, 410b, 410c of a real-world environment 100. In FIG. 4(a) is illustrated a user 140 located in a real-world environment 100 represented by a room. The user 140 is wearing an XR device 110 that has access to a 3D digital representation 410a of the real-world environment 100. However, the XR device 110 does not have any knowledge of the user's 140 positioning relative to the room itself. The user 140 can see the real-world environment 100. In FIG. 4(b) is provided an illustration where the user 140 has been prompted to orient himself/herself towards three feature points 130a:130c in the real-world environment 100. Orientation data as obtained for when the user 140 is oriented towards each of the feature points 130a:130c can then be cross-references with data points that in the 3D digital representation 410b represent the feature points 130a:130c. In the illustrated example, each of the three feature points 130a:130c is represented by a respective corner in the room. The user 140 moves his/her head and looks at, or gazes at, the feature points 130a:130c. Orientation data of the XR device 110 for when the user 140 is oriented towards each of the feature points 130a:130c is then obtained. The head motions and eye gaze of the user 140 is registered, determining the directions/poses the user 140 is in. As no sensors are used to determine the distances between the user 140 and each feature point 130a:130c, only direction, angle, and relative movement of the user 140 between registered feature points 130a:130c are used to create vectors extending through the user and the feature points 130a:130c. According to FIG. 4(c) the location of the user 140 (and thus of the XR device 110) is determined by comparing where the registered vectors meet, enabling the user 140 to be correctly (virtually) placed in the 3D digital representation 410c, as indicated by the virtual user 140′ wearing a virtual XR device 110′.

As disclosed above, the controller 200 in S112 performs localization of the XR device 110 by cross-referencing the orientation data with data points that in the 3D digital representation 410a:410c represent the feature point 130a:130c. Reference is here made to FIG. 5.

In FIG. 5 is schematically illustrated views as displayed on the user interface 112 of an XR device 110. It is understood that these are simplified views since the true views displayed on the user interface 112 generally are 3D stereoscopic images. Here, the user 140 is assumed to look towards a door 120 in the real-world environment. A virtual door 510a, 510b, 510c, 510d is therefore displayed as an overlay on the door 120. As shown in FIG. 5(a)-5(d), depending on the relative distance and orientation of the XR device 110 with respect to the door 120, the virtual door 510a, 510b, 510c, 510d will thus have a different relative size, position, and orientation with respect to the door 120. A feature point 130a is located at the upper right-hand corner of a door 120. The feature point 130a has a correspondence to a data point located at the upper right-hand corner of the virtual door 510a, 510b, 510c, 510d in the 3D digital representation. According to the example in FIG. 5(a), the feature point 130a is distanced a distance di from the data point 520a located at the upper right-hand corner of the virtual door 510a. Further, the virtual door 510a appears to be larger than the door 120, indicating that the XR device 110 is located farther away from the door 120 than as estimated from current positioning information of the XR device 110. According to the example in FIG. 5(b), the feature point 130a is distanced a distance d2 from the data point 520b located at the upper right-hand corner of the virtual door 510b. Further, the virtual door 510b appears to be smaller than the door 120, indicating that the XR device 110 is located closer to the door 120 than as estimated from current positioning information of the XR device 110. According to the example in FIG. 5(c), the feature point 130a is distanced a distance d3 from the data point 520c located at the upper right-hand corner of the virtual door 510c. Further, the virtual door 510c is oriented as offset to the left of the door 120, indicating that the XR device 110 is located farther to the left of the door 120 than as estimated from current positioning information of the XR device 110. According to the example in FIG. 5(d), the feature point 130a and the data point 520d located at the upper right-hand corner of the virtual door 510d almost coincide. Further, the virtual door 510d is oriented to almost overlap perfectly with the door 120, indicating that the XR device 110 has been correctly localized.

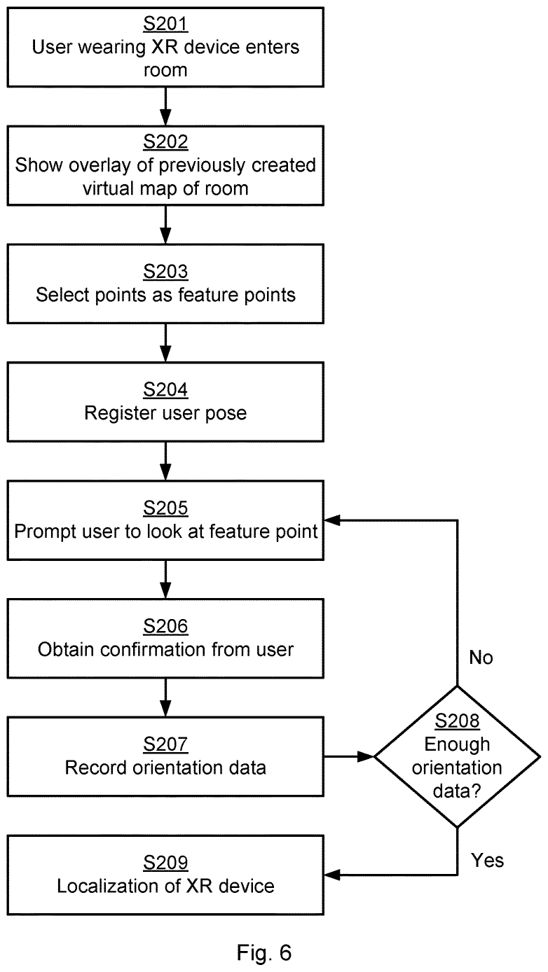

Reference is next made to the flowchart of FIG. 6 illustrating a method for performing localization of an XR device 110 in accordance with at least some of the above disclosed embodiments, aspects, and examples. A user 140, wearing an XR device 110, is entering a room (S201). The XR device 110 shows an overlay of a previously created virtual map of the room, selected by either the user 140 manually selecting it from a list, or larger map, and/or based on the position of the XR device 110 (S202). Distinct points in the room are selected as feature points 130a:130c (S203). The user's current pose is registered (S204). One of the feature points 130a:130c is selected and the user 140 is prompted to look at the real-world equivalent (S205). Confirmation is obtained that the user 140 is looking at the real-world equivalent of the selected feature point 130a:130c (S206). Orientation data of the XR device 110 for when the user 140 is oriented towards the feature point 130a:130c is recorded (S207). It is checked whether enough orientation data of the XR device 110 has been obtained or not to localize the XR device 110 (S208). The procedure can be repeated for more feature points 130a:130c (by action S205 being entered again for a new selected feature point 130a:130c) until the controller 200 deems the information received is sufficient to localize the XR device 110 virtually in the map, matching the real-world location. Localization of the XR device 110 is then performed based on all obtained orientation data of the XR device 110 with respect to the different feature points 130a:130c (S209).

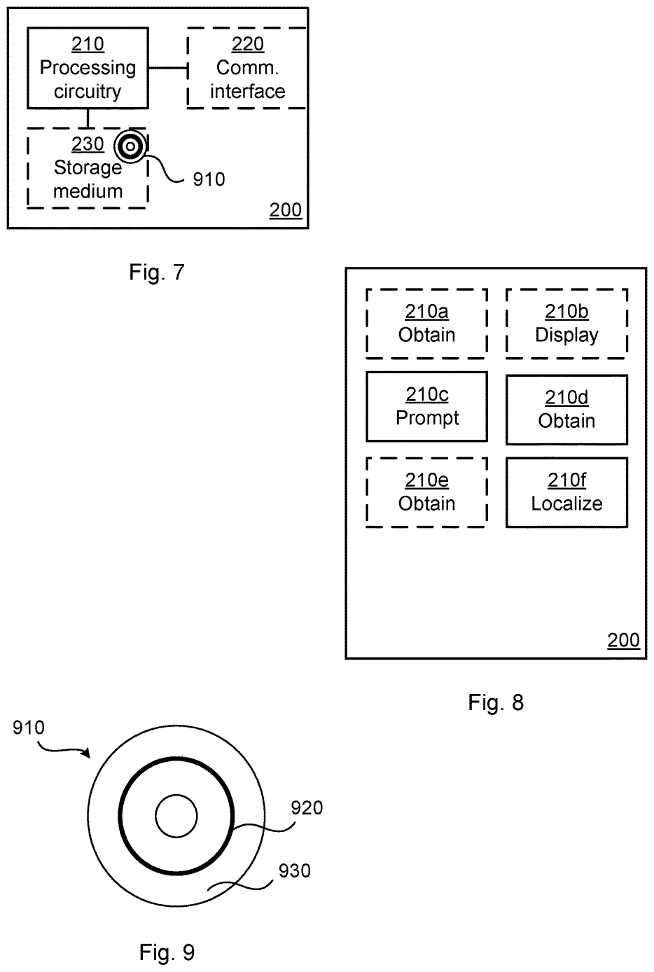

FIG. 7 schematically illustrates, in terms of a number of functional units, the components of a controller 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the controller 200 to perform a set of operations, or actions, as disclosed above. For example, the storage medium 230 may store the set of operations, and the processing circuitry 210 may be configured to retrieve the set of operations from the storage medium 230 to cause the controller 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The controller 200 may further comprise a communications (comm.) interface 220 at least configured for communications with other entities, functions, nodes, and devices. As such the communications interface 220 may comprise one or more transmitters and receivers, comprising analogue and digital components. The processing circuitry 210 controls the general operation of the controller 200 e.g. by sending data and control signals to the communications interface 220 and the storage medium 230, by receiving data and reports from the communications interface 220, and by retrieving data and instructions from the storage medium 230. Other components, as well as the related functionality, of the controller 200 are omitted in order not to obscure the concepts presented herein.

FIG. 8 schematically illustrates, in terms of a number of functional modules, the components of a controller 200 according to an embodiment. The controller 200 of FIG. 8 comprises a number of functional modules; a prompt module 210c configured to perform action S106, an obtain module 210d configured to perform action S108, and a localize module 21of configured to perform action S112. The controller 200 of FIG. 8 may further comprise a number of optional functional modules, such as any of an obtain module 210a configured to perform action S102, a display module 210b configured to perform action S104 and/or S114, and an obtain module 210e configured to perform action S110. In general terms, each functional module 210a: 210f may in one embodiment be implemented only in hardware and in another embodiment with the help of software, i.e., the latter embodiment having computer program instructions stored on the storage medium 230 which when run on the processing circuitry makes the controller 200 perform the corresponding actions mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 210a: 210f may be implemented by the processing circuitry 210, possibly in cooperation with the communications interface 220 and/or the storage medium 230. The processing circuitry 210 may thus be configured to from the storage medium 230 fetch instructions as provided by a functional module 210a: 210f and to execute these instructions, thereby performing any actions as disclosed herein.

As disclosed above, the controller 200 may be provided as a standalone device or as a part of at least one further device. Thus, a first portion of the instructions performed by the controller 200 may be executed in a first device, and a second portion of the of the instructions performed by the controller 200 may be executed in a second device; the herein disclosed embodiments are not limited to any particular number of devices on which the instructions performed by the controller 200 may be executed. Hence, the methods according to the herein disclosed embodiments are suitable to be performed by a controller 200 residing in a cloud computational environment. Therefore, although a single processing circuitry 210 is illustrated in FIG. 7 the processing circuitry 210 may be distributed among a plurality of devices, or nodes. The same applies to the functional modules 210a:210f of FIG. 8 and the computer program 920 of FIG. 9.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any actions as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A controller for performing localization of an extended reality (XR) device, wherein the controller comprises processing circuitry, and wherein the processing circuitry is configured to cause the controller to:
prompt a user of the XR device to orient himself/herself towards a feature point in a real-world environment;
obtain orientation data of the XR device for when the user is oriented towards the feature point; and
perform localization of the XR device for matching the feature point to a three-dimensional (3D) digital representation of the real-world environment by cross-referencing the orientation data with data points that in the 3D digital representation represent the feature point.

2. The controller of claim 1, wherein the 3D digital representation has been generated prior to the localization being performed.

3. The controller of claim 1, wherein
the 3D digital representation is a 3D scene graph of the real-world environment.

4. The controller of claim 1, wherein
the 3D digital representation comprises point or mesh information of the real-world environment and semantic information of objects in the real-world environment.

5. The controller of claim 4, wherein
the feature point is selected based on location of the point or mesh information and/or the semantic information.

6. The controller of claim 1, wherein
the feature point is a first feature point and wherein the processing circuitry is configured to cause the controller to repeat the prompting and the obtaining for at least one second feature point in the real-world environment, and to perform the localization of the XR device also based on said at least one second feature point.

7. The controller of claim 6, wherein
matching each of the first feature point and the at least one second feature point to the 3D digital representation comprises determining a respective vector, each vector pointing towards a respective one of the first feature point and the at least one second feature point, and wherein the localization of the XR device is defined by a coordinate in a plane or space where two or more of the vectors are estimated to cross each other.

8. The controller of claim 6, wherein
the first feature point and the at least one second feature point are all placeable on one and the same straight line.

9. The controller of claim 1, wherein
the user is prompted to orient himself/herself towards the feature point by gazing towards the feature point, and wherein matching the feature point to the 3D digital representation comprises gaze tracking of the user.

10. The controller of claim 1, wherein
the user is prompted to orient himself/herself towards the feature point by directly facing the feature point and wherein matching the feature point to the 3D digital representation comprises pose tracking of the XR device.

11. The controller of claim 1, wherein
the processing circuitry is configured to cause the controller to:
obtain first positioning information of the XR device and second positioning information of at least one other XR device located in the real-world environment and wherein the localization of the XR device further is based on a comparison between the first positioning information and the second positioning information.

12. The controller claim 1, wherein
the processing circuitry is configured to cause the controller to, in conjunction with prompting the user to orient himself/herself towards the feature point, and/or when having performed the localization of the XR device:
display the 3D digital representation as a virtual overlay on the XR device.

13. The controller of claim 12, wherein
the virtual overlay comprises an indication of the feature point.

14. The controller of claim 1, wherein
the processing circuitry is configured to cause the controller to:
obtain an indication that prompts localization of the XR device to be performed, and wherein the user of the XR device is prompted to orient himself/herself towards the feature point in the real-world environment in response thereto.

15. The controller of claim 14, wherein
the indication pertains to any, or any combination, of:
an indication of unexpected change of luminosity in the real-world environment,
an indication of deviation from an expected correspondence between the 3D digital representation and the real-world environment,
an indication from a program or an application requiring higher positioning accuracy or confirmation of position of the XR device in the real-world environment,
user input indicating a need for calibration of the XR device,
an indication of deviation from an expected position of the XR device relative other XR devices.

16. The controller of claim 1, wherein
the user of the XR device is prompted to orient himself/herself towards the feature point in the real-world environment by the controller causing a message to be played out on the XR device.

17. A non-transitory computer readable storage medium storing a computer program for performing localization of an XR device, the computer program comprising computer code which, when run on processing circuitry of a controller, causes the controller to:
prompt a user of the XR device to orient himself/herself towards a feature point in a real-world environment;
obtain orientation data of the XR device for when the user is oriented towards the feature point; and
perform localization of the XR device for matching the feature point to a 3D digital representation of the real-world environment by cross-referencing the orientation data with data points that in the 3D digital representation represent the feature point.

18. (canceled)
